(19) United States
(12) Patent Application Publication
(10) Pub. No.: US 2021/0218747 A1
(43) Pub. Date: Jul. 15, 2021

(54) SYSTEM AND METHOD FOR COMPUTER NETWORK COMMUNICATION

(71) Applicant: AXIS CYBER SECURITY LTD., Tel-Aviv (IL)

(72) Inventors: GIL AZRIELANT, TEL-AVIV (IL); DOR KNAFO, TEL-AVIV (IL)

(21) Appl. No.: 17/147,620

(22) Filed: Jan. 13, 2021

Related U.S. Application Data
(60) Provisional application No. 62/960,167, filed on Jan. 13, 2020.

(51) Int. Cl. H04L 29/06

(52) U.S. Cl. CPC H04L 63/101; H04L 67/42; H04L 63/08

(57) ABSTRACT

A disarm and reconstruction system for client requests to an application, is described. The system includes a deconstruction module to deconstruct the client request to components, such as headers and their values, and a reconstruction module to determine if the components are permitted or non-permitted components. Non-permitted components, which may be malicious, are removed and a request is reconstructed using the permitted components. The reconstructed request can then be safely sent to the application.

### FIELD

The present invention relates to protecting communication over a computer network. In one embodiment the invention relates to traffic between a client and an application.

### BACKGROUND

Telecommunication, using a variety of protocols, is widely employed by enterprises globally. Over the past years, enterprises face increasingly sophisticated threats that target, among others, the traffic over computer networks.

Defenses employed to secure computer network traffic include filters, such as firewall, and intrusion detection or prevention systems, which look for suspicious traffic once it has passed through the firewall. In some cases, an access broker, that acts as a security policy enforcement point, is placed between service providers and consumers. However, current day security solutions are not effective against all threats. For example, some worm-like vulnerabilities that could spread from one computer to another, are a daunting security challenge, despite patches that were released to fix such vulnerabilities.

With computers and devices connected everywhere, such vulnerabilities could have potentially disastrous effects not only on businesses, but on government organizations, smart buildings, healthcare, and more.

### SUMMARY

Embodiments of the invention provide protection from vulnerabilities by ensuring that only uncompromised requests are transferred to applications.

Additionally, embodiments of the invention enable organizations to isolate their applications and provide access to these applications only to a set of privileged/authorized users.

Embodiments of the invention provide a system and method for protecting applications (and thus protecting their host servers and related networks). An access broker, according to embodiments of the invention, operates at the application layer acting as a termination point for client requests. Terminated requests are deconstructed and dangerous components in the deconstructed request are identified and disarmed. The request is then reconstructed without the dangerous components. Thus, potentially harmful requests may be modified such that they are stripped of identified vulnerabilities. The reconstructed request, which is now stripped of vulnerabilities, is then sent to the application.

Because applications are, typically, on a private network, the application can only be accessed via the access broker, thereby preventing access of unmonitored traffic to the application and limiting exposure of other layers to attacks.

In some embodiments, a request is processed via additional one or more protecting and security-enhancing phases such as validation, authentication and authorization, to increase the chance that an accessed application is isolated from malicious requests and is approached only by authenticated and authorized users.

Requests that have been processed via one or a combination of additional phases, are logged to a log file to maintain an audit trail that can help in the event of a security issue, to understand and fix the problem.

### BRIEF DESCRIPTION OF THE DRAWINGS

The invention will now be described in relation to certain examples and embodiments with reference to the following illustrative drawing figures so that it may be more fully understood. Aspects of the invention are described with reference to flowchart illustrations and/or block diagrams of methods, systems, and computer program products according to embodiments of the invention. It will be understood that each block of the flowchart illustrations and/or block diagrams, and combinations of blocks in the flowchart illustrations and/or block diagrams, can be implemented by computer readable program instructions.

In the drawings:

FIGS. 1A and 1B schematically illustrate, correspondingly, a system and method for protecting a computer network, according to embodiments of the invention;

FIGS. 2A and 2B schematically illustrate, correspondingly, a disarm and reconstruct unit and method for protecting an application, including disarming a request, according to embodiments of the invention; and

FIGS. 3A and 3B schematically illustrate, correspondingly, a method for protecting an application and the pipeline used in the method, according to embodiments of the invention.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

As used herein, the terms “component”, “module”, “unit”, “system” and the like refer to computer-related entities; hardware, firmware, software, a combination of software and hardware, or the execution of software. For example, a component or module may include a process running on a processor, a thread of execution, a program, and/or a computer. A module can be localized within one computer or distributed between multiple computers. Modules can execute from various computer readable media having various data structures stored thereon.

Any of the elements shown in the Figures below are preferably implemented by one or more computers in computer hardware and/or in computer software embodied in a non-transitory, computer-readable medium in accordance with conventional techniques.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

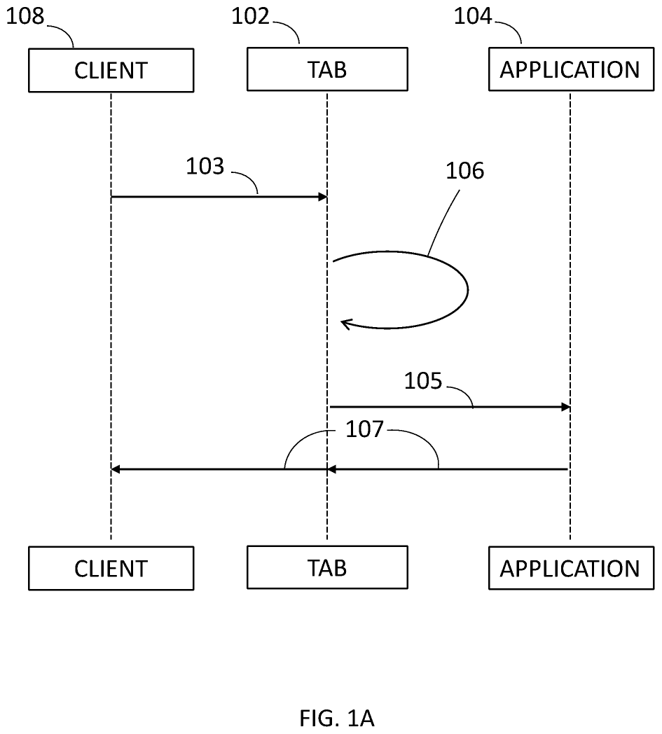

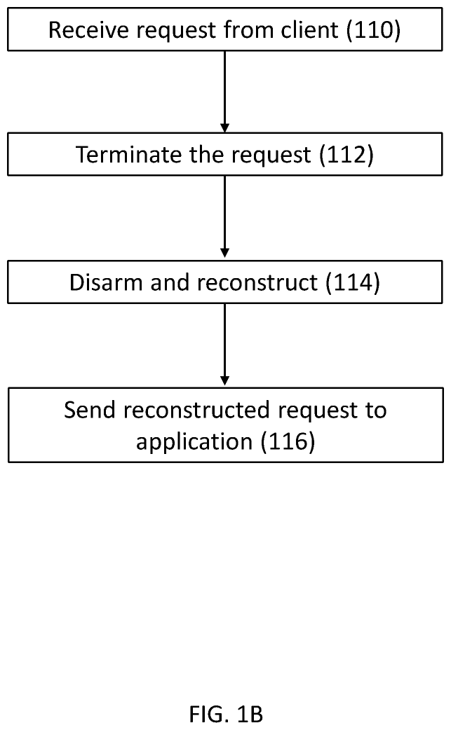

Reference is now made to FIG. 1A, which is a simplified conceptual illustration of a system for protecting a computer network, constructed and operative in accordance with an embodiment of the invention. In the system of FIG. 1A, an application 104, which is typically on a private network (e.g., an enterprise network) is approached by a client 108, which is typically on a different network (e.g., a public network), via an access broker which is on both networks. The access broker, referred to herein as a terminating access broker (TAB) 102, is configured to receive and terminate a request 103 sent from the client 108, to the application 104, e.g., at a server. The TAB 102, or a unit in communication with the TAB, may disarm and reconstruct (DR) 106 the request 103, to produce a disarmed request 105. The TAB 102 then sends the disarmed request 105 to the application 104.

In some embodiments, the TAB 102 is configured to receive a response 107 from the application 104 and to send the response 107 to the client 108.

Typically, TAB 102 operates at the application layer of a computer network, enabling the TAB 102 to read and modify requests and responses at this layer. Since the TAB 102 is on the private network and the client is not, the application 104 may only be accessed by the client 108 via the TAB 102, thereby preventing access of unmonitored traffic to the application and limiting exposure of other layers to attacks.

Computers in a computer network (such as the network illustrated in FIG. 1A) may communicate via a wired or wireless connection. Computers may communicate via a network such as local area network (LAN) or wide area network (WAN) using, for example, Ethernet or Wi-Fi. Communication may be via local and/or remote processes.

TAB 102 may be implemented in a unit, such as an application delivery controller, or in a server proxy that acts as a gateway between networks (e.g., a private network and the internet). TAB 102 may include, for example, an identity-aware proxy, a forward proxy and/or a reverse proxy.

An exemplary method for protecting computer network communication, carried out by a unit such as TAB 102 and/or a disarm and reconstruct unit that may be in communication with TAB 102, is schematically illustrated in FIG. 1B. The method includes receiving, at an access broker, a request from a client to an application (step 110) and terminating the request (step 112). The terminated request is disarmed and reconstructed (step 114) and the reconstructed request is then sent to the application (step 116).

Disarming the received request (in step 114) typically includes deconstructing the request into components and detecting permitted and non-permitted components. The permitted (but not the non-permitted) components are then used to obtain the reconstructed request that is sent to the application.

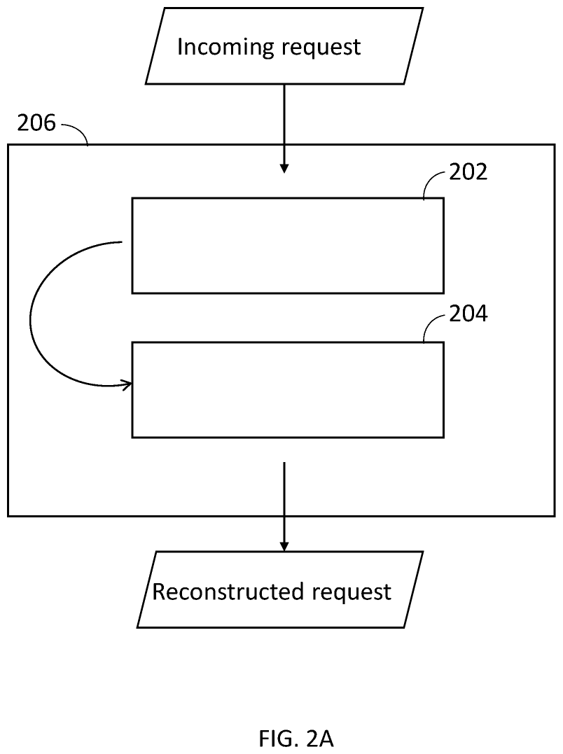

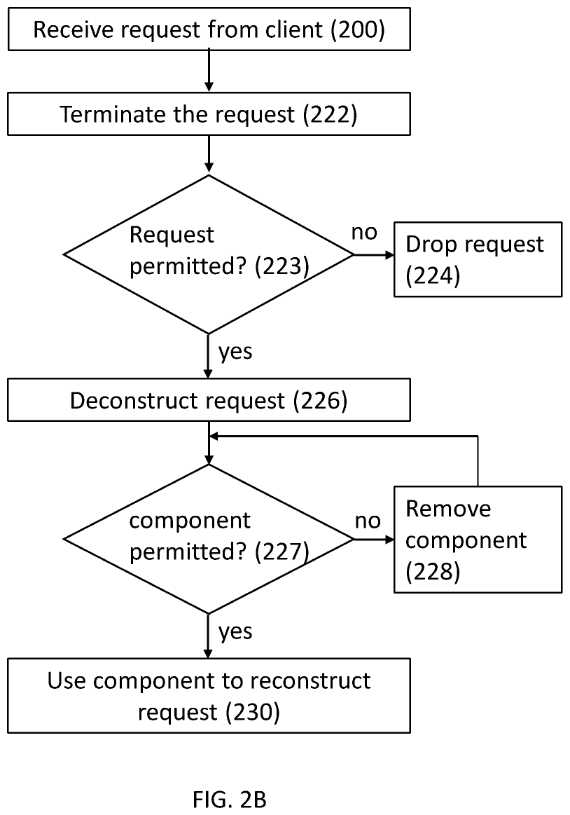

FIG. 2A schematically illustrates a disarm and reconstruction (DR) unit 206 for disarming requests, according to embodiments of the invention. Requests (also referred to as packets or protocol data units (PDUs)), typically include control information (header) and user data (payload).

An incoming request terminated, e.g., by TAB 102, is input to the DR unit 206, where it is deconstructed, by a deconstruct module 202, disarmed and then reconstructed by a reconstruct module 204.

Deconstruct module 202 may use, for example, isolated containers to provide a disarm environment for the requests where a parser (or similar component) may be used to deconstruct the request into one or more components, such as, headers and their values.

In some embodiments, a plurality of DR units may be used, possibly simultaneously. Incoming PDUs may be classified by a controller, e.g., based on the type of protocol used by the application being accessed, and may then be routed, e.g., by the controller, to a specific isolation container based on their classification.

Components of a PDU are determined to be permitted or non-permitted, for example, by using a validator and/or comparing components to a list, e.g., checking against a whitelist and/or blacklist. In some embodiments, a list (e.g., whitelist/blacklist) is specific per application, e.g., specific to a protocol of the application. For example, components of a PDU can be compared to an application-specific list of permitted or non-permitted components to determine if the components deconstructed by module 202, are permitted or non-permitted.

To disarm the request, non-permitted components (e.g., headers or values that are not on the whitelist and/or are on a blacklist and/or are determined to be non-permitted by a validator) are removed.

In some cases, the DR unit 206 or a processor in communication with the DR unit 206 may create a permitted component (e.g., header or value) to replace a removed non-permitted component. The newly created component can then be used in reconstruction of the request. By creating a new permitted component to replace a removed component, DR unit 206 ensures that even hidden vulnerabilities are not inserted into a reconstructed request.

Reconstruct module 204 then reconstructs a request from the permitted components, thereby producing a reconstructed request. The reconstructed request, which does not include non-permitted components, can now be sent, e.g., by a controller, such as TAB 102 or other unit, to the application.

In some embodiments, a PDU is validated, namely, determined to conform with a protocol (e.g., application-specific protocol), prior to deconstructing the request. Thus, only validated requests are transferred to the DR unit 206 for disarming.

Non-permitted PDUs (e.g., requests to an application that are not on the whitelist specific to that application) are dropped.

An exemplary method for protecting an application, including disarming and reconstructing a PDU, carried out, for example, by DR unit 206, is schematically illustrated in FIG. 2B.

A request to an application is received (step 200), e.g., at an access broker. The request is terminated (step 222) and then validated, namely, checked against (one or more) protocols of the application, to determine if it is a permitted request. For example, the request can be checked against a protocol-specific whitelist and/or blacklist. Requests that are included in the whitelist are considered permitted and requests that are not included in the whitelist or included in a blacklist, are non-permitted.

If the request is determined to be non-permitted (decision point 223), the request is dropped (step 224) and is not forwarded to the application. If the request is permitted (decision point 223) the request is deconstructed into components (step 226). Each component is then checked to determine if it is permitted or not (decision point 227). For example, the components can be checked against a whitelist and/or blacklist and/or by using a validator, to determine if they are permitted or non-permitted.

Permitted components are used to reconstruct the request (step 230) and non-permitted components are removed (step 228).

Thus, a reconstructed request produced by DR unit 206 contains only components that comply with the application policy and protocol, and which contain no harmful information. As such, the reconstructed request may be safely sent to the application.

In one exemplifying case, an access broker, such as TAB 102, serves as a broker for a remote desktop protocol (RDP) application having a policy of blocking file-transfers. If a file-transfer request is received at the access broker, it will be checked against a list which does not permit file-transfers, per the application policy. Based on the comparison to the list, the request will be determined to be non-permitted and will be dropped and not forwarded to the application, thereby protecting the application.

In another exemplifying case, CVE 2017-5638 is a vulnerability in Apache Struts—a popular web application framework used by enterprises to build their internal applications. This vulnerability essentially allows a user to run commands on remote servers without permission, by sending invalid values on the Content-Type HTTP header.

This request can be sent despite not being compliant with the Hypertext Transfer Protocol (HTTP), and can be crafted to cause different behaviors on the server side.

If a request containing this (or similar) vulnerability is received at a system according to embodiments of the invention, it will be disarmed, as described herein. The header of this request will be determined to be non-permitted (e.g., by being compared to a HTTP-specific whitelist and/or blacklist). The Content-Type header containing the invalid values will be removed such that, the request containing the vulnerability will not be forwarded to the remote server, thereby preventing the attack and protecting the remote server. Possibly the header containing the invalid values may be replaced by a newly created valid header such that the request may be forwarded to the remote server with no vulnerability.

In yet another example, a worm-like vulnerability named BlueKeep can send malware packets to operating systems that use or enable RDP, causing heap corruption, which allows for arbitrary code execution at the system level.

If a request containing a BlueKeep (or similar) vulnerability is received at a system according to embodiments of the invention, it will be disarmed, as described herein. At least one value of the request will be determined to be non-permitted (e.g., by comparing to an RDP-specific whitelist) and will be removed. Thus, a request containing the BlueKeep vulnerability will not be forwarded to a remote server, thereby preventing the attack and protecting the remote server and the computer network.

An access broker, such as TAB 102, terminates traffic but does not change the protocol at either client or application end, thus, neither client nor application are aware of it. Therefore, embodiments of the invention enable information technology (IT) managers and Security and Operations teams (for example) to protect their organization's applications, their underlying data and their underlying infrastructure, from attempts to compromise them, without requiring a change to users' or applications' workflow.

The network traffic, e.g., requests and responses, is terminated, by TAB 102, at the application layer. As discussed above, operating at the application layer limits the traffic across the network to the bare required minimum and mitigates the risk of adversaries attacking the lower layers of the network model (e.g., Open Systems Interconnection (OSI) model) or gaining access to unauthorized neighboring applications.

In some embodiments, a request is processed via a pipeline which can include one or a combination of protecting and security-enhancing phases, after which, if successfully passing all phases of the pipeline, the request can be sent with no risk to the application.

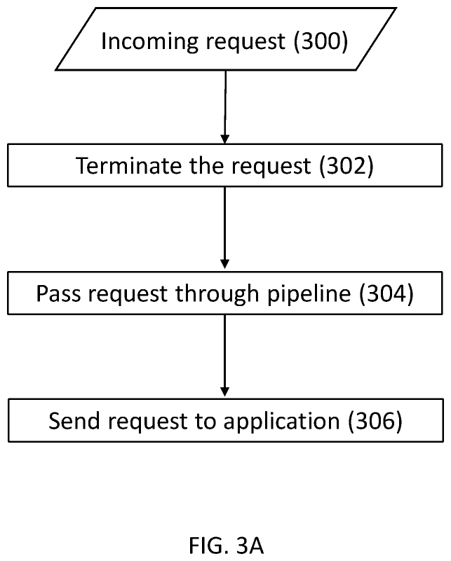

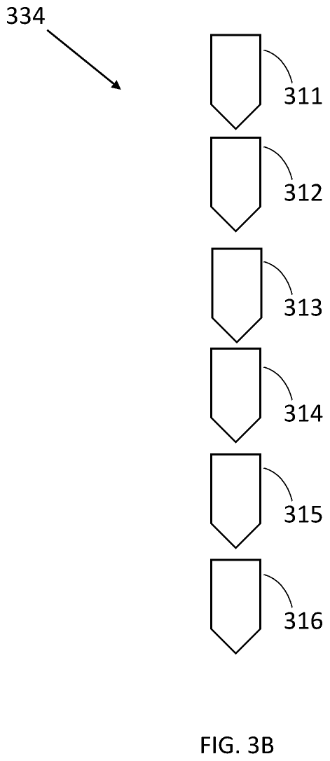

In one embodiment, which is schematically illustrated in FIG. 3A, an incoming request 300 is terminated 302 and passed through a pipeline 304. After passing all phases of the pipeline the request is sent to an application 306. A response may be sent “as-is” from the application back to the client.

In one example, which is schematically illustrated in FIG. 3B, a pipeline unit 334 includes a phase 311 of adding context to the incoming request, a phase 312 of validating the request, a phase 313 of disarming the request, a phase 314 of authenticating the disarmed request, a phase 315 of authorizing the disarmed request and a phase 316 of logging the request.

Pipelines having more or less, possibly differently arranged and ordered, phases may be applied on requests, according to embodiments of the invention.

An access broker, according to embodiments of the invention, may be configured to preform one or more of the pipeline phases exemplified in FIG. 3B and described below.

### Phase 311—Adding Context

Adding context to a request may include, for example, providing information, such as, location, geoIP, IP address, time, application usage history, device identifiers, data from the identity provider, user info, endpoint info, and more. The information added to a request at this phase may provide details that can be used by downstream phases, such as by phase 315 (authorization) and/or phase 316 (log).

### Phase 312—Validation

In one embodiment, an access broker, such as TAB 102, or a unit in communication with the access broker, validates the request against a given protocol. Since the access broker knows the application it brokers access to, the appropriate protocol is known to the access broker in advance. As described above, packets that do not validate against the protocol at this phase, are dropped and do not advance through the pipeline.

### Phase 313—Disarming

As described above, a system, according to embodiments of the invention, is configured to disarm a request. A request gets deconstructed and re-constructed. Non-permitted headers and/or values are removed from the reconstructed packet, allowing only permitted PDUs, headers, and values to pass through the pipeline. The request now passing through the pipeline is a validated and disarmed and reconstructed request.

### Phase 314—Authentication

An access broker, such as TAB 102, or a unit in communication with the access broker, may be configured to authenticate a reconstructed request. The access broker may use the original protocol of the application in order to authenticated the request without requiring the user to change their workflow, and without modifying the application or its host server.

In one embodiment, the access broker can use the existing protocol to add an additional step, typically, another step that is native to the protocol. Adding a step native to the protocol may include, for example, a prompt for an additional password for an SSH (Secure Shell) session, an inner-login screen for RDP sessions, or a redirect chain that checks cookies on identity providers for HTTP sessions. This method does not require the user to visit a portal.

In another possible embodiment, a parameter is added to the protocol's initial request. This generally means adding a secret to one of the fields that are received by the access broker on the initial request. This can include, for example, adding a mstshash cookie for RDP sessions and encoding a secret to the server name indication (SNI) used for HTTP. Adding a secret to these requests may require the user to get a connection string, or a file (depending on the protocol) from a portal.

### Phase 315—Authorization

An access broker, such as TAB 102, or a unit in communication with the access broker, can use a policy engine to determine if a request (in this example, an already validated, disarmed, and authenticated request) is authorized. In one example, the access broker sends the request details, along with any relevant context (e.g., user info and endpoint info that were added at phase 311), to receive a “Block” or “Allow” verdict, in accordance with the policy.

### Phase 316—Log

Typically, every request, and the context added to the request (e.g., at phase 311), whether allowed or blocked, is logged in a log file. This log may help, for example, in the event of a breach or vulnerability exploitation, to understand and fix the vulnerability that allowed it to happen.

Requests that have successfully passed all phases of pipeline unit 334 contain only safe components (e.g., ensured at phase 313), comply with relevant policies and protocols (e.g., ensured at phases 312, 313 and 315), are confirmed to be sent from an identified user (e.g., ensured in phase 314) and can be tracked and analyzed (e.g., by using phases 311 and 316). Thus, embodiments of the invention provide improved visibility and safety to traffic over a computer network.

Unless specifically stated otherwise, as apparent from the description above, it is appreciated that throughout the specification discussions utilizing terms such as “analyzing”, “processing,” “computing,” “calculating,” “determining,” “detecting”, “identifying”, “sending”, “receiving” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Unless otherwise stated, these terms refer to automatic action of a processor, independent of and without any actions of a human operator.

What is claimed is:

1. A system for protecting a computer network, the system comprising:
a disarm and reconstruction unit configured to
receive from an access broker a terminated client request,
disarm the client request, and
reconstruct the client request to produce a disarmed request,
wherein the access broker sends the disarmed request to the application.

2. The system of claim 1 wherein the disarm and reconstruction unit is configured to
deconstruct the request into components,
determine one or more permitted and non-permitted component,
remove the non-permitted component, and
reconstruct the request using the permitted component.

3. The system of claim 2 wherein the disarm and reconstruction unit determines one or more of a permitted component and a non-permitted component by comparing the component to a list.

4. The system of claim 3 wherein the list is specific to a protocol of the application.

5. The system of claim 2 wherein the disarm and reconstruction unit determines one or more of a permitted component and a non-permitted component by applying a validator.

6. The system of claim 2 wherein the components comprise one or more of a header and a value of the header.

7. The system of claim 6 and further comprising a processor configured to create a permitted component to replace a removed non-permitted component, the permitted component to be used to reconstruct the request.

8. The system of claim 1 wherein the access broker is located at an application layer of the computer network.

9. The system of claim 1 wherein the access broker is configured to validate the request against a protocol of the application and allow only a validated request to be received at the disarm and reconstruction unit.

10. The system of claim 1 and further comprising a pipeline unit configured to perform one or more of a) adding context to the request, b) authenticating the reconstructed request, and c) authorizing the reconstructed request.

11. The system of claim 10 wherein the pipeline unit is configured to log the request to which context was added and which was authenticated and authorized.

12. The system of claim 1 wherein the access broker is configured to receive a response from the application and to send the response to the client.

13. A method for protecting computer network communication, the method comprising
terminating a client request to an application;
deconstructing the request into components;
detecting permitted components and non-permitted components;
using the permitted components exclusive of the non-permitted components to obtain a reconstructed request; and
sending the reconstructed request to the application.

14. The method of claim 13 and further comprising terminating the request at an application layer of the computer network.

15. The method of claim 13 and further comprising determining that the request conforms with a protocol of the application prior to deconstructing the request.

16. The method of claim 15 and further comprising:
processing the request through a pipeline of phases including one or more of a) adding context to the request, b) authenticating the reconstructed request, and c) authorizing the reconstructed request; and
sending the reconstructed request to the application only if the request successfully passes all phases of the pipeline.

17. The method of claim 16 and further comprising logging the request for assisting in understanding and fixing a vulnerability in a breach event.

18. The method of claim 13 and further comprising receiving a response from the application and sending the response to the client.

19. A disarm and reconstruction system for protocol data units (PDU), the system comprising:
a deconstruction module configured to deconstruct the PDU into components; and
a reconstruction module configured to determine if the components are permitted components or non-permitted components and to provide a reconstructed PDU from any of the permitted components; and
a controller to send the reconstructed PDU to an application.

20. The disarm and reconstruction system of claim 19, wherein the system is configured to create a new permitted component to replace a non-permitted component and to provide the reconstructed PDU using the new permitted component.
